(19) United States
(12) Patent Application Publication
(10) Pub. No.: US 2012/0224015 A1
(43) Pub. Date: Sep. 6, 2012

(54) THERMAL HEAD AND METHOD OF MANUFACTURING THE SAME

(76) Inventors: Norimitsu SANBONGI, Chiba-shi (JP); Noriyoshi SHOJI, Chiba-shi (JP); Toshimitsu MOROOKA, Chiba-shi (JP); Keitaro KOROISHI, Chiba-shi (JP)

(21) Appl. No.: 13/409,230

(22) Filed: Mar. 1, 2012

(30) Foreign Application Priority Data
Mar. 4, 2011 (JP) 2011-047711

(51) Int. Cl. B41J 2/335; B05D 5/00; B05D 5/12

(52) U.S. Cl. 347/203; 427/58

(57) ABSTRACT

Adopted is a thermal head, including: a heating resistor provided on a support substrate; a pair of electrode formed on the heating resistor so as to be spaced apart in a direction along a surface of the heating resistor, the pair of electrodes respectively having inclined surfaces which are spaced apart from each other as a distance from the support substrate increases; a burying film for burying a region between the pair of electrodes; and a protective film formed on the region buried by the burying film and on the pair of electrodes.

### BACKGROUND OF THE INVENTION

1. Field of the Invention

The present invention relates to a thermal head for use in a printer and the like, and a method of manufacturing the thermal head.

2. Description of the Related Art

In thermal heads for use in printers, as illustrated in FIG. 12, there has been conventionally known a problem in that steps formed on a heating resistor 107 because of electrodes 108 are transferred also in an upper surface of a protective film 109, to thereby generate an air layer 106 between thermal paper 12 and the protective film 109 (heating portion 107A). Therefore, heat generated at the heating portion 107A is not sufficiently transmitted toward the thermal paper 12, which leads to reduction in printing efficiency.

To address this problem, as illustrated in FIG. 13, there has been conventionally known a thermal head including a partial glaze 120 formed on an upper surface of a substrate, and a heating resistor 107 and electrodes 108 formed so that centers thereof are positioned near a top portion of the partial glaze 120 (for example, see Japanese Patent Application Laid-open No. Hei 05-24230). In this thermal head, the heating portion 107A is protruded with respect to the electrodes 108 formed on the heating resistor 107, to thereby improve a contact state between the thermal paper 12 and the heating portion 107A. Thus, the printing efficiency is improved.

However, in the method disclosed in Japanese Patent Application Laid-open No. Hei 05-24230, the following steps are necessary: printing glaze paste on the upper surface of the substrate; baking the glaze paste; and forming the partial glaze 120 having a stable arched shape. Therefore, the number of manufacturing steps increases, and hence there has been a disadvantage of manufacturing cost increase.

Further, a plurality of thermal heads are manufactured on one substrate, and hence in the method disclosed in Japanese Patent Application Laid-open No. Hei 05-24230, it is necessary to pattern each of the heating resistor 107 and the electrodes 108 correspondingly to the top portion of the partial glaze 120. However, due to errors in printing accuracy of the partial glaze 120 or patterning accuracy of the heating resistor 107 and the electrodes 108 (photomask accuracy, exposure positioning accuracy, and the like), the center of the heating portion 107A may be deviated from the top portion of the partial glaze 120, or positions of the centers of the heating portions 107A may vary. As a result, there has been a disadvantage that, for example, an expected printing efficiency cannot be obtained.

To address this disadvantage, there has been known a method in which the partial glaze is not used, that is, the steps on the heating resistor generated by the electrodes are eliminated with use of an insulating material (burying film), to thereby form the surface of the protective layer flat or into a convex shape (for example, see Japanese Patent Application Laid-open No. 2010-179551).

However, in the method disclosed in Japanese Patent Application Laid-open No. 2010-179551, normal etching processing is performed, and hence an edge portion of each of the electrodes becomes substantially 90°. Further, a resist mask used for electrode patterning is used as a lift-off resist mask as it is, and film formation is performed on the resist mask. Therefore, due to shades of side wall surfaces of the electrodes and the resist mask, recessed portions are generated in the burying film in the vicinity of the electrodes. Therefore, when the burying film is removed by lift-off and the protective film is sequentially formed thereon, a discontinuous protective film layer is formed above the recessed portions, which causes faults in the protective film.

With the faults in the protective film, reliability and durability of the thermal head dramatically decrease due to the following reasons.

(1) In the thermal head, during printing, short and successive pulse power is applied to the heating resistor to generate heat. Therefore, due to difference in thermal expansion coefficient resulting from difference of materials for the glaze layer, the electrode, and the protective film at the heating portion, expansion and contraction occur and a thermal stress is applied. The thermal stress converges to the fault portion in the protective film. Thus, there occur strain and failure of intimate contact at the fault, which causes peeling of the protective film.

(2) On the heating portion, the thermal paper slides while being strongly pressed by a platen roller, and hence a mechanical stress is applied. The mechanical stress converges to the fault portion in the protective film, to thereby cause peeling of the protective film.

(3) The thermal paper contains ion components in minute amounts. The ion components are attracted to the electrode through the fault in the protective film of the thermal head by the voltage applied during printing, which causes corrosion of the electrode. As a result, there occurs failure of intimate contact between the protective film and the electrode, which causes peeling of the protective film.

That is, according to the method disclosed in Japanese Patent Application Laid-open No. 2010-179551, the steps in the protective film generated by the electrodes (and the air layer generated by the steps) are eliminated, which improves the printing efficiency, but there is a disadvantage that the reliability and durability of the thermal head dramatically decrease.

### SUMMARY OF THE INVENTION

The present invention has been made in view of the above-mentioned circumstances, and it is an object thereof to provide a thermal head which is capable of improving printing efficiency by eliminating steps in a protective film generated by electrodes, and also improving reliability and durability of the thermal head, and to provide a method of manufacturing the thermal head.

In order to achieve the above-mentioned object, the present invention employs the following measures.

According to a first aspect of the present invention, there is provided a method of manufacturing a thermal head, including: forming a heating resistor on a substrate; forming a pair of electrodes on the heating resistor so as to be spaced apart in a direction along a surface of the heating resistor, the pair of electrodes respectively having inclined surfaces which are spaced apart from each other as a distance from the substrate increases; burying a region between the pair of electrodes; and forming a protective film on the buried region and on the pair of electrodes.

According to the first aspect of the present invention, in the forming of a heating resistor, the heating resistor is formed on the substrate, and in the forming of a pair of electrodes, the pair of electrodes is formed on the heating resistor so as to be spaced apart in the direction along the surface of the heating resistor. Then, in the burying, the region between the pair of electrodes is buried, and in the forming of a protective film, the protective film is formed on the buried region and the pair of electrodes.

In this case, in the forming of a pair of electrodes, the inclined surfaces are respectively formed to the pair of electrodes, the inclined surfaces being spaced apart from each other as the distance from the substrate increases. With this, in the burying, the region between the pair of electrodes can be buried to be formed flat without forming recessed portions in the vicinity of the electrodes. As a result, in the forming of a protective film, the protective film can be uniformly formed on the buried region and on the pair of electrodes without faults.

As described above, according to the first aspect of the present invention, the steps on the heating resistor generated by the electrodes are eliminated, and further, the thermal head including the protective film without faults can be manufactured. According to the thermal head thus manufactured, an air layer between the protective film and a platen roller, which is generated by the steps of the electrodes, is eliminated, which makes it possible to improve the printing efficiency. Further, it is possible to prevent occurrence of a disadvantage to be caused by the faults of the protective film described above, and also possible to improve the reliability and the durability of the thermal head.

In the first aspect of the present invention, the forming a pair of electrodes may include: forming an electrode layer on the substrate; forming a first mask on the electrode layer on both sides of the heating resistor with a space therebetween; removing a region of the electrode layer, which is not covered with the first mask, by etching processing with use of solvent having permeability; and removing the first mask.

With this, in the forming of a pair of electrodes, the following steps are performed. In the forming of an electrode layer, the electrode layer is formed on the substrate, and in the forming of a first mask, the first mask is formed on the electrode layer on both the sides of the heating resistor with the space therebetween. Then, in the removing of a region of the electrode layer, the region of the electrode layer, which is not covered with the first mask, is removed. After that, in the removing of the first mask, the first mask is removed.

In this case, in the removing of a region of the electrode layer, by performing etching processing with use of solvent having permeability, the region of the electrode layer, which is not covered with the first mask, is removed in the vertical direction (thickness direction of the electrode layer), and further, the solvent penetrates also in the lateral direction (direction along the surface of the electrode layer) from the region to remove the electrode layer. In this manner, the inclined surfaces are respectively formed to the pair of electrodes, the inclined surfaces being spaced apart from each other as the distance from the substrate increases. With this, in the burying, the region between the pair of electrodes can be buried to be formed flat. As a result, in the forming of a protective film, the protective film can be uniformly formed without faults.

In the first aspect of the present invention, the burying may include: forming a second mask on the pair of electrodes; forming a burying film between the pair of electrodes and on the second mask; and removing the second mask.

With this, in the burying, the following steps are performed. In the forming of a second mask, the second mask is formed on the pair of electrodes, and in the forming of a burying film, the burying film is formed between the pair of electrodes and on the second mask. Then, in the removing of the second mask, the second mask is removed, and thus the burying film formed on the second mask is also removed. With this, it is possible to bury the region between the pair of electrodes by the burying film to be formed flat. Thus, in the forming of a protective film, the protective film can be uniformly formed without faults.

In the first aspect of the present invention, the inclined surfaces may each be formed at an angle ranging from 15° to 60° with respect to the substrate.

With this, in the burying, the region between the pair of electrodes can be suitably buried, which makes it possible to improve the flatness of the region and uniformly form the protective film in the forming of a protective film.

According to a second aspect of the present invention, there is provided a thermal head, including: a heating resistor provided on a substrate; a pair of electrodes provided on the heating resistor so as to be spaced apart in a direction along a surface of the heating resistor, the pair of electrodes respectively having inclined surfaces which are spaced apart from each other as a distance from the substrate increases; a burying film for burying a region between the pair of electrodes; and a protective film formed on the region buried by the burying film and on the pair of electrodes.

According to the second aspect of the present invention, similarly to the first aspect, the steps on the heating resistor generated by the electrodes are eliminated, and further the protective film can be formed without faults. With such a thermal head, the air layer between the protective film and the platen roller, which is generated by the steps of the electrodes, is eliminated, which makes it possible to improve the printing efficiency. Further, it is possible to prevent occurrence of a disadvantage caused by the faults of the protective film described above, and thus the reliability and the durability of the thermal head can be improved.

In the second aspect of the present invention, the inclined surfaces may each be formed at an angle ranging from 15° to 60° with respect to the substrate.

With this, the region between the pair of electrodes can be suitably buried, which makes it possible to improve the flatness of the region and uniformly form the protective film.

According to the present invention, the following effects are produced. The printing efficiency is improved by eliminating the steps in the protective film generated by the electrodes, and the reliability and the durability of the thermal head are improved.

### BRIEF DESCRIPTION OF THE DRAWINGS

In the accompanying drawings:

FIG. 1 is a schematic structural view of a thermal printer according to a first embodiment of the present invention;

FIG. 2 is a plan view of a thermal head of FIG. 1 viewed from a protective film side;

FIG. 3 is a cross-sectional view taken along the arrow A-A of the thermal head of FIG. 2;

FIG. 4 is a flow chart illustrating a method of manufacturing the thermal head of FIG. 2;

FIG. 5 is a flow chart illustrating details of an electrode forming step of FIG. 4;

FIG. 6 is a flow chart illustrating details of a burying step of FIG. 4;

FIGS. 7A to 7E are views illustrating states in a process of manufacturing the thermal head of FIG. 2, in which FIG. 7A illustrates the electrode forming step; FIG. 7B, the burying step (lift-off resist mask forming step); FIG. 7C, the burying step (burying film forming step); FIG. 7D, the burying step (lift-off resist mask removing step); and FIG. 7E, a protective film forming step;

FIGS. 8A and 813 are views illustrating states of the thermal head in the burying step (lift-off resist mask forming step), in which FIG. 8A is a side view and FIG. 8B is a plan view;

FIG. 9 is a view illustrating a contact state of the thermal head of FIG. 2 and a platen roller;

FIGS. 10A to 10D are views illustrating states in a conventional process of manufacturing a thermal head;

FIGS. 11A to 11D are views illustrating states in a burying step of the conventional thermal head;

FIG. 12 is a view illustrating a contact state of a conventional thermal head and a platen roller; and

FIG. 13 is a view illustrating a contact state of a conventional thermal head and the platen roller.

### DETAILED DESCRIPTION OF THE PREFERRED EMBODIMENT

A thermal head 1 according to an embodiment of the present invention is described below with reference to the accompanying drawings.

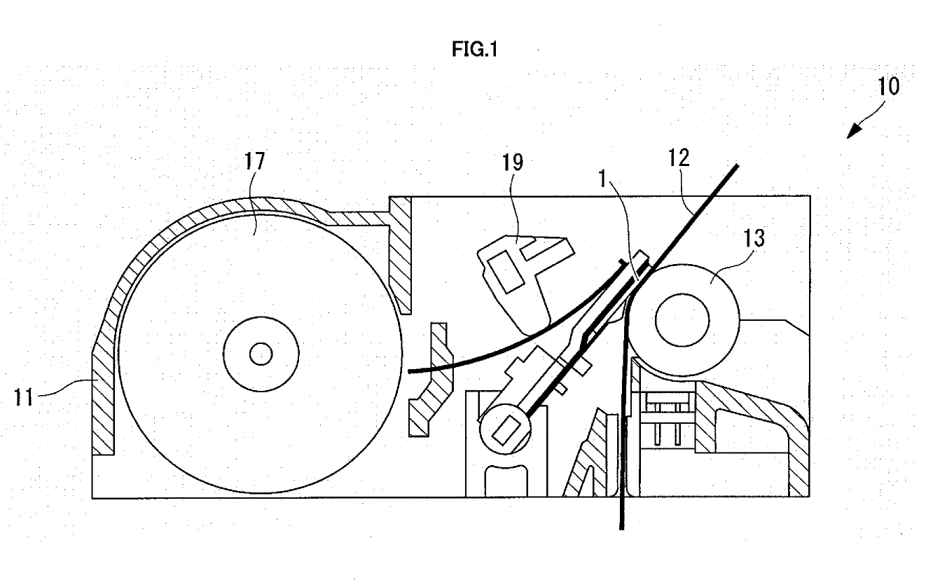

The thermal head 1 according to this embodiment is used for, for example, a thermal printer 10 as illustrated in FIG. 1, and performs printing on an object to be printed, such as thermal paper 12, by selectively driving a plurality of heating elements based on printing data.

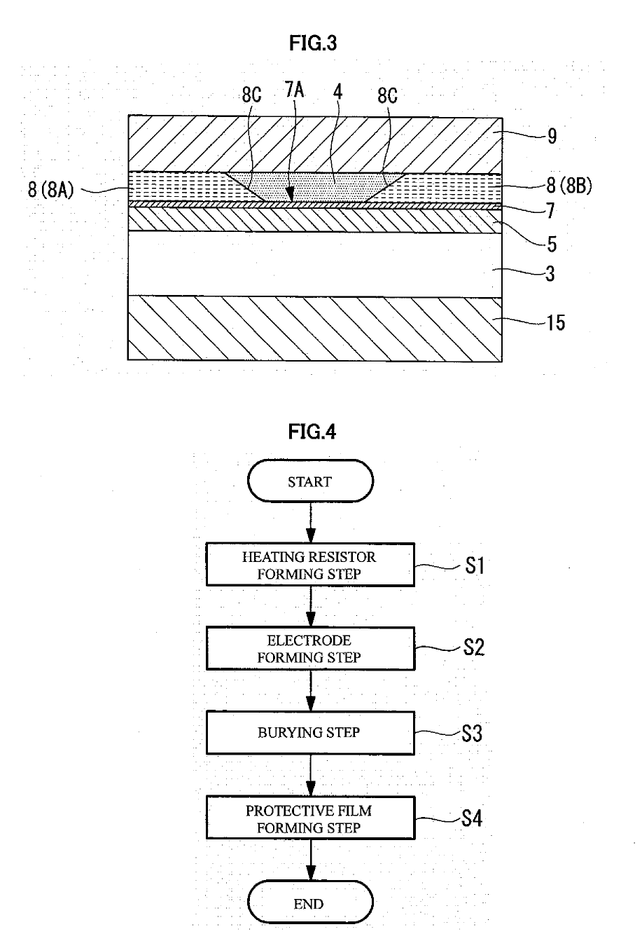

The thermal printer 10 includes a main body frame 11, a platen roller 13 disposed with its central axis being horizontal, the thermal head 1 disposed opposite to an outer peripheral surface of the platen roller 13, a heat dissipation plate 15 (see FIG. 3) supporting the thermal head 1, a paper feeding mechanism 17 for feeding the thermal paper 12 between the platen roller 13 and the thermal head 1, and a pressure mechanism 19 for pressing the thermal head 1 against the thermal paper 12 with a predetermined pressing force.

Against the platen roller 13, the thermal head 1 is pressed via the thermal paper 12 by the operation of the pressure mechanism 19. Accordingly, a reaction force of the platen roller 13 is applied to the thermal head 1 via the thermal paper 12.

The heat dissipation plate 15 is a plate-shaped member made of a metal such as aluminum, a resin, ceramics, glass, or the like, and serves for fixation and heat dissipation of the thermal head 1.

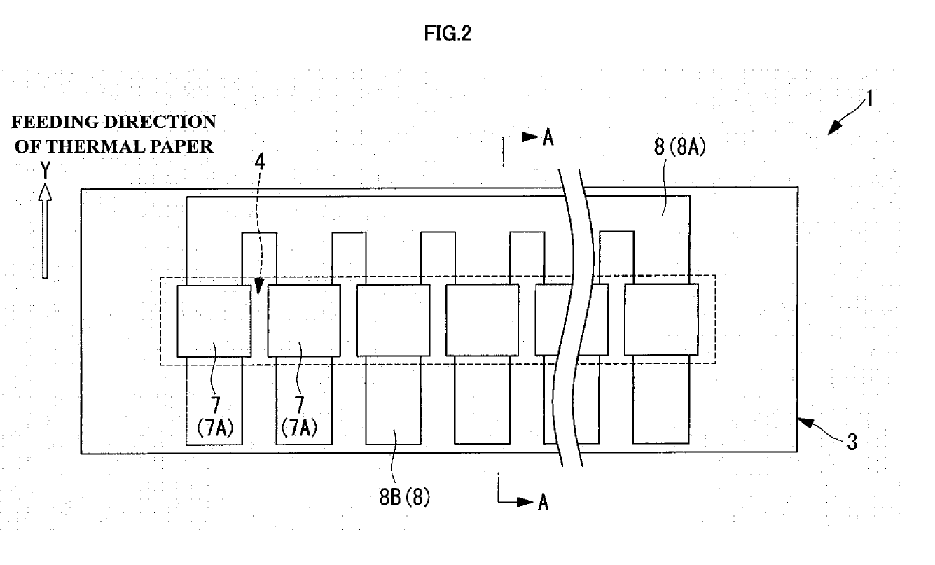

As illustrated in FIG. 2, in the thermal head 1, a plurality of heating resistors 7 and a plurality of electrodes 8 are arrayed in a longitudinal direction of a rectangular support substrate 3. The arrow Y represents a feeding direction of the thermal paper 12 by the paper feeding mechanism 17.

FIG. 3 illustrates a cross-section taken along the arrow A-A of FIG. 2. As illustrated in FIG. 3, the thermal head 1 includes the support substrate 3 supported by the heat dissipation plate 15, a glaze 5 formed on an upper surface side of the support substrate 3, the heating resistors 7 provided on the glaze 5, the pairs of electrodes 8 provided at both end portions of the heating resistors 7, a burying film 4 for burying a region between the pair of electrodes 8, and a protective film 9 for covering the burying film 4 and the electrodes 8 to protect the burying film 4 and the electrodes 8 from abrasion and corrosion.

The support substrate 3 is, for example, an insulating substrate such as a glass substrate or a silicon substrate having a thickness approximately ranging from 300 μm to 1 mm. Here, as the support substrate 3, a ceramic sheet containing an alumina component of 99.5% is used.

The glaze 5 is formed of, for example, a glass material having a thickness approximately ranging from 10 μm to 100 μm, and functions as a heat storage layer for storing heat generated from the heating resistor 7.

As illustrated in FIG. 2, the plurality of heating resistors 7 are arrayed on the upper surface of the glaze 5 at predetermined intervals in the longitudinal direction of the support substrate 3. The heating resistors 7 are each formed of, for example, a Ta—N film or a Ta—SiO₂ film, which has tantalum (Ta) as a main component. A specific method of forming the heating resistors 7 is described later.

The electrodes 8 are used to allow the heating resistors 7 to generate heat. As illustrated in FIG. 2, the electrodes 8 include a common electrode 8A connected to one end of each of the heating resistors 7 in a direction orthogonal to the array direction of the heating resistors 7, and individual electrodes 8B connected to another end of each of the heating resistors 7. The common electrode 8A is integrally connected to all the heating resistors 7, and the respective individual electrodes 8B are connected to each of the heating resistors 7.

When voltage is selectively applied to the individual electrodes 8B, current flows through the heating resistors 7 which are connected to the selected individual electrodes 8B and the common electrode 8A opposed thereto, to thereby allow the heating resistors 7 to generate heat. In this state, the pressure mechanism 19 operates to press the thermal paper 12 against a surface portion (printing portion) of the protective film 9 covering the heating portions of the heating resistors 7, and then color is developed on the thermal paper 12 to be printed.

Further, as illustrated in FIG. 3, the common electrode 8A and the individual electrode 8B respectively include inclined surfaces 8C which are spaced apart from each other as the distance from the support substrate 3 increases. A specific method of forming the inclined surfaces 8C is described later. Note that, a portion of the heating resistor 7 which actually generates heat (hereinafter, the heating portion is referred to as “heating portion 7A”) is a portion of the heating resistor 7 which is not overlapped with the electrodes 8A and 8B, that is, a region of the heating resistor 7 between a connection surface of the common electrode 8A and a connection surface of the individual electrode 8B.

The burying film 4 and the protective film 9 are made of the same material, and are formed by, for example, coating a mixed film of Si₃N₄ and SiO₂ by sputtering and the like. A specific method of forming the burying film 4 and the protective film 9 is described later.

Next, a method of manufacturing the thermal head 1 having the above-mentioned structure is described below.

As illustrated in FIG. 4, the method of manufacturing the thermal head 1 according to this embodiment includes a heating resistor forming step S1 of forming the heating resistor 7 on the support substrate 3 (glaze 5), an electrode forming step S2 of forming the pair of electrodes 8 on the heating resistor 7 so as to be spaced apart in a direction along the surface of the heating resistor 7, a burying step S3 of burying a region between the pair of electrodes 8, and a protective film forming step S4 of forming the protective film 9 on the buried region and the pair of electrodes 8. Hereinafter, the above-mentioned steps are specifically described.

In the heating resistor forming step S1, as a heating resistor material, a Ta—N film, or a Ta-SiO₂ film, which has tantalum (Ta) as a main component, is formed by sputtering to have a thickness of approximately 0.1 μm. After that, by photolithography, the plurality of heating resistors 7 are formed at predetermined intervals in the longitudinal direction of the support substrate 3.

The electrode forming step S2 includes, as illustrated in FIG. 5, as detailed sub-steps, an electrode layer forming step S21 of forming an electrode layer on the support substrate 3 (glaze 5), an electrode pattern resist mask forming step S22 of forming an electrode pattern resist mask (first mask) 21 on the electrode layer on both sides of the heating portion 7A with a space therebetween, an electrode layer removing step S23 of removing a region of the electrode layer, which is not covered with the electrode pattern resist mask 21, by etching processing with use of solvent having permeability, and an electrode pattern resist mask removing step S24 of removing the electrode pattern resist mask 21.

In the electrode layer forming step S21, as an electrode material for supplying power to the heating resistor 7, an electrode layer formed of an Al film, an Al—Si film, or an Al—Si—Cu film, which has Al as a main component, is formed on the support substrate 3 (glaze 5) by, for example, sputtering to have a thickness approximately ranging from 1 μm to 2 μm.

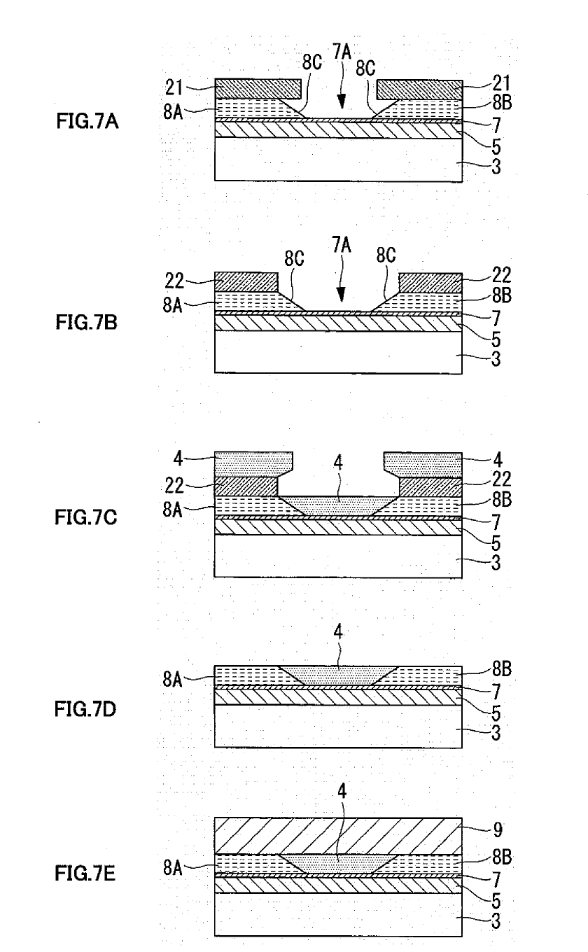

In the electrode pattern resist mask forming step S22, as illustrated in FIG. 7A, a photoresist is applied on the electrode layer on both the sides of the heating portion 7A, and exposure and development are performed with use of a photomask, to thereby form the electrode pattern resist mask 21 in a manner sandwiching the heating portion 7A (with a space).

In the electrode layer removing step S23, etching processing is performed with use of an etchant such as a mixed acid aqueous solution containing phosphoric acid, acetic acid, nitric acid, and pure water, whose viscosity is adjusted by its mixture ratio. In this case, when the Al film (electrode layer) is subjected to etching with an etchant having low viscosity, the etchant contributes to Al etching, and at the same time, the etchant enters the interface between the electrode pattern resist mask 21 and the Al film, which causes the etching to progress also in the direction along the surface of the electrode layer. By appropriately adjusting the relationship of the etching rate in the direction along the surface of the electrode layer and the etching rate in the film thickness direction, when the etching is completed, the inclined surfaces 8C may be formed in the electrode layer in a manner sandwiching the heating portion 7A and being spaced apart from each other as the distance from the support substrate 3 (glaze 5) increases.

Note that, the inclined surface 8C is preferred to be formed at an angle ranging from 15° to 60° with respect to the support substrate 3. With such an inclination angle, in the burying step S3 described later, a region between the pair of electrodes 8 may be suitably buried by the burying film 4.

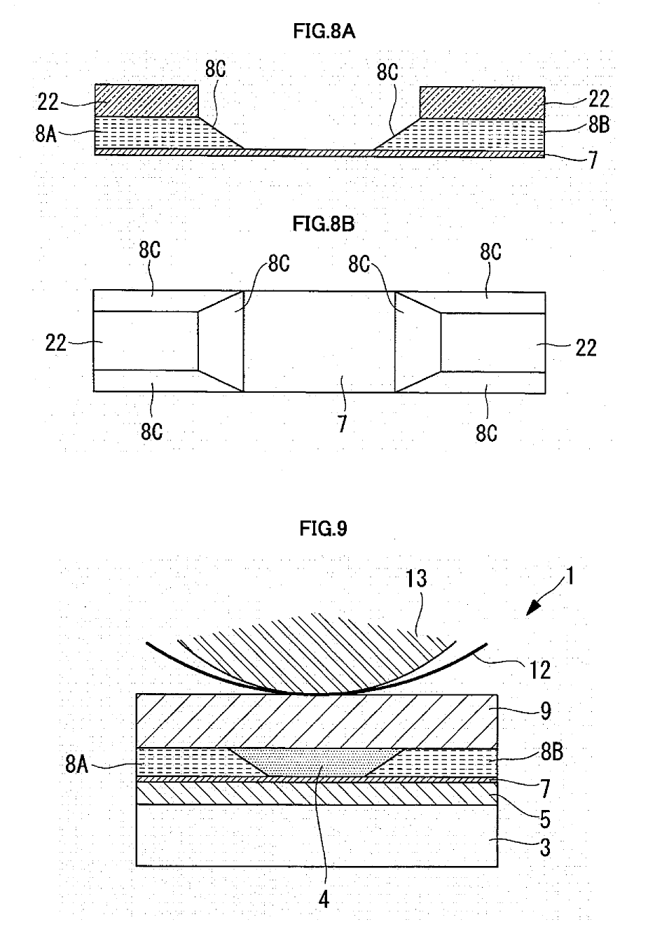

Further, as illustrated in FIGS. 8A and 8B, the inclined surface 8C is preferred to be provided not only in the longitudinal direction of the heating resistor 7 but also in the direction orthogonal to the longitudinal direction of the heating resistor 7. With this, regions between the plurality of electrodes 8 arrayed in the longitudinal direction of the support substrate 3 may be suitably buried by the burying film 4.

In the electrode pattern resist mask removing step S24, the electrode pattern resist mask 21 is removed with use of a remover such as an organic solvent, and thus the electrodes 8 including the inclined surfaces 8C are exposed.

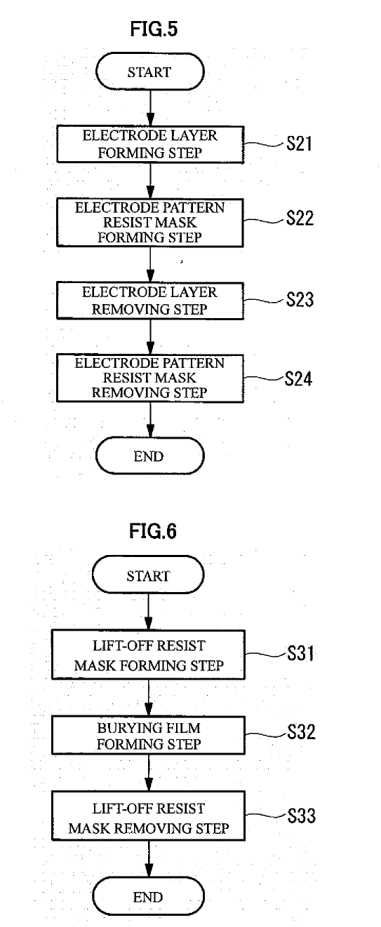

The burying step S3 includes, as illustrated in FIG. 6, as detailed sub-steps, a lift-off resist mask forming step S31 of forming a lift-off resist mask (second mask) 22 on the pair of electrodes 8, a burying film forming step S32 of forming the burying film 4 on the support substrate 3 having the lift-off resist mask 22 partially formed thereon, and a lift-off resist mask removing step S33 of removing the lift-off resist mask 22.

In the lift-off resist mask forming step S31, as illustrated in FIG. 7B, a photoresist is applied onto the pair of electrodes 8 again, and exposure and development are performed with use of a photomask designed so as to have the same shape as the upper surfaces of the electrodes 8. In this manner, the lift-off resist mask 22 is formed on the upper surfaces of the electrodes 8.

In the burying film forming step S32, as illustrated in FIG. 7C, on the lift-off resist mask 22 and the heating resistor 7, the burying film 4 made of the same insulating material as the protective film 9 is deposited by, for example, sputtering to have a thickness substantially the same as the thickness of a step between the heating resistor 7 and the electrode 8. Thus, the step is eliminated. In this case, the pair of electrodes 8 is provided with the inclined surfaces 8C, and hence the region between the pair of electrodes 8 can be buried to be formed flat without forming recessed portions in the vicinity of the electrodes 8. As for this point, a burying state in a case where the inclined surfaces 8C are not formed is described later as a comparative example.

In the lift-off resist mask removing step S33, as illustrated in FIG. 7D, the lift-off resist mask 22 is removed with use of a remover such as an organic solvent.

In the protective film forming step S4, as illustrated in FIG. 7E, in order to prevent oxidation and abrasion of the heating resistor 7 and the electrodes 8, for example, a mixed film of Si₃N₄ and SiO₂ is formed by sputtering so as to cover the heating resistor 7 and the electrodes 8 at a thickness approximately ranging from 3 μm to 6 μm, to thereby form the protective film 9. In this case, by forming the burying film 4 and the protective film 9 with use of the same material, a continuous film is formed in the thickness direction. Further, the protective film 9 is formed without faults even above the heating resistor 7 and the electrodes 8, and hence the protective film 9 is continuous also in the planar direction (direction along the surface of the support substrate 3).

### Comparative Example

Now, as a comparative example, a conventional method of manufacturing a thermal head is described below.

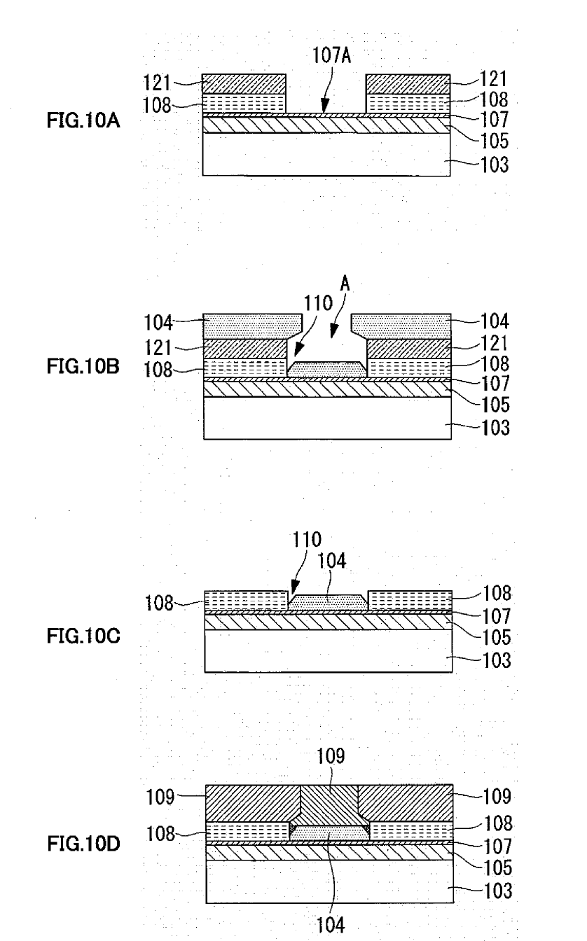

The conventional method of manufacturing a thermal head 101 includes, as illustrated in FIGS. 10A to 10D, a heating resistor forming step, an electrode forming step, a burying step, and a protective film forming step. Hereinafter, the above-mentioned steps are specifically described.

In the heating resistor forming step, similarly to the heating resistor forming step Si of the thermal head 1 according to this embodiment, a plurality of heating resistors 107 are formed at predetermined intervals in a longitudinal direction of a support substrate 103.

In the electrode forming step, a pair of electrodes 108 are formed on the heating resistor 107 so as to be spaced apart in a direction along the surface of the heating resistor 107. In this case, according to the conventional method of manufacturing the thermal head 101, as illustrated in FIG. 10A, an electrode pattern resist mask 121 is formed on the electrode layer on both sides of a heating portion 107A, and normal etching processing is performed. Therefore, side walls of the pair of electrodes 108 are formed in a direction orthogonal to the surface of the heating resistor 107. That is, unlike the thermal head 1 according to this embodiment, the pair of electrodes 108 is not provided with the inclined surfaces 8C.

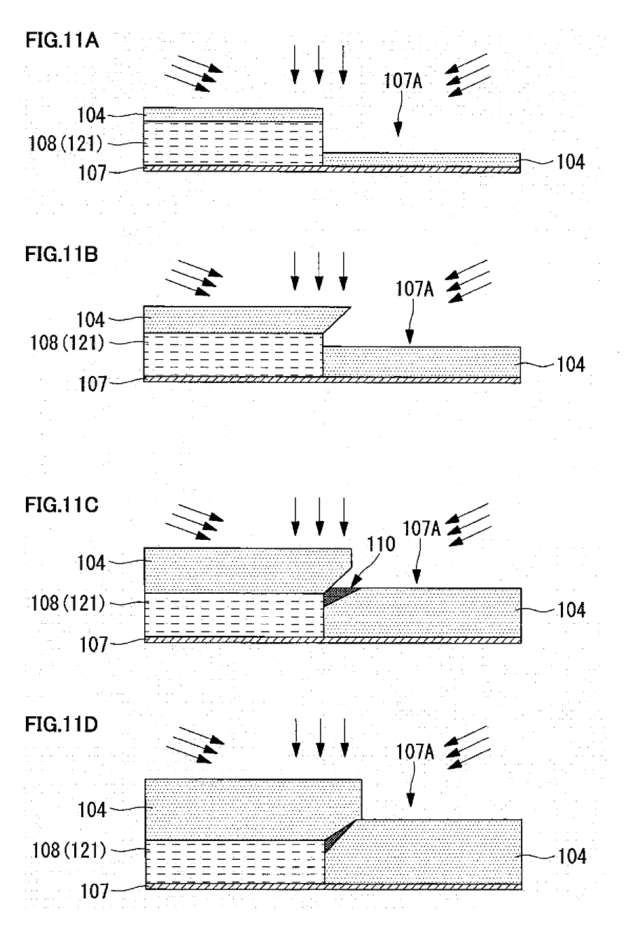

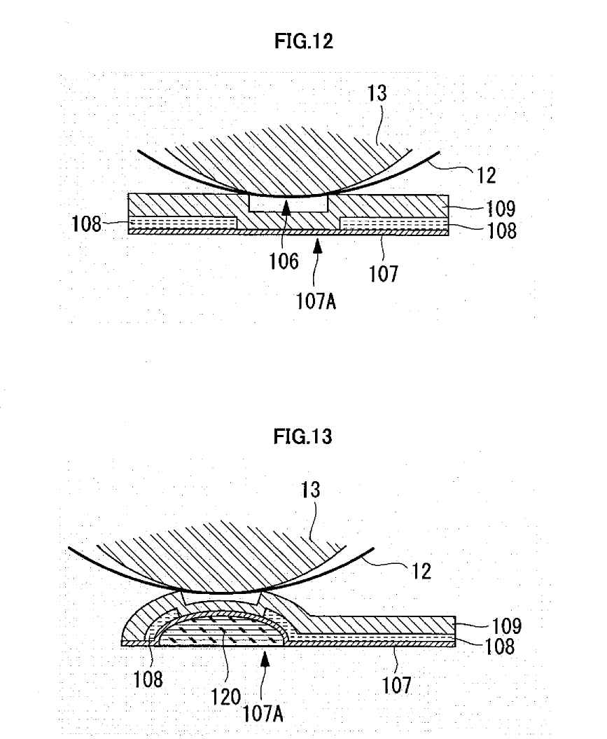

In the burying step, as illustrated in FIG. 10B, a burying film 104 is formed on the electrode pattern resist mask 121 and the heating resistor 107. In this case, recessed portions 110 are formed at part A in the vicinity of the pair of electrodes 108. The formation process of the recessed portion 110 is described below with reference to FIGS. 11A to 11D.

FIGS. 11A to 11D are views illustrating time-series states of the burying film 104 in the burying step of the conventional thermal head 101.

As illustrated in FIG. 11A, in the burying step, a film is deposited on a substrate set in a deposition device while the substrate is rotated and revolved. In this case, sputtered particles having directivity are applied to the substrate surface from various directions.

When the film formation is performed under this state, as illustrated in FIG. 11B, the burying film 104 is laminated on the electrode 108 so as to be projected toward the heating portion 107A.

When the film formation is continued under this state, as illustrated in FIG. 11C, due to a shade of a side wall surface of the electrode 108 (and a shade of a side wall surface of the electrode pattern resist mask 121), the recessed portion 110 is generated in the burying film 104 in the vicinity of the electrode 108.

When the film formation is further continued, as illustrated in FIG. 11D, a discontinuous burying film 104 is formed above the recessed portion 110, which causes a fault in the burying film 104.

In the protective film forming step, as illustrated in FIG. 10C, the electrode pattern resist mask 121 and the burying film 104 laminated thereon are removed. Then, as illustrated in FIG. 10D, on the burying film 104 in which the recessed portion 110 or the fault is formed as described above, a protective film 109 is formed. In this case, due to the recessed portion 110 or the fault formed in the burying film 104, a discontinuous protective film layer is formed above the recessed portion 110, which causes a fault in the protective film 109.

With the fault in the protective film 109, reliability and durability of the thermal head dramatically decrease due to the following reasons.

(1) In the thermal head, during printing, short and successive pulse power is applied to the heating resistor to generate heat. Therefore, due to difference in thermal expansion coefficient resulting from difference of materials for the glaze layer, the electrode, and the protective film at the heating portion, expansion and contraction occur and a thermal stress is applied. The thermal stress converges to the fault portion in the protective film. Thus, there occur strain and failure of intimate contact at the fault, which causes peeling of the protective film.

(2) On the heating portion, the thermal paper slides while being strongly pressed by a platen roller, and hence a mechanical stress is applied. The mechanical stress converges to the fault portion in the protective film, to thereby cause peeling of the protective film.

(3) The thermal paper contains ion components in minute amounts. The ion components are attracted to the electrode through the fault in the protective film of the thermal head by the voltage applied during printing, which causes corrosion of the electrode. As a result, there occurs failure of intimate contact between the protective film and the electrode, which causes peeling of the protective film.

In contrast, according to the method of manufacturing the thermal head 1 of this embodiment, as described above, in the electrode forming step S2, with respect to the pair of electrodes 8, the inclined surfaces 8C are formed, which are spaced apart from each other as the distance from the support substrate 3 increases. With this, in the burying step S3, the region between the pair of electrodes 8 is buried so as to be formed flat without forming the recessed portion in the vicinity of the electrodes 8. As a result, in the protective film forming step S4, the protective film 9 can be uniformly formed without a fault being formed above the buried region and the pair of electrodes 8.

As described above, according to the method of manufacturing the thermal head 1 of this embodiment, as illustrated in FIG. 7E, the steps on the heating resistor 7 generated by the electrodes 8 can be eliminated, and the thermal head 1 including the protective film 9 without a fault can be manufactured. With the thermal head 1 manufactured as described above, it is possible to prevent occurrence of a disadvantage to be caused by the fault of the protective film 9 described above, and also possible to improve the reliability and the durability of the thermal head.

Further, according to the thermal head I of this embodiment, as illustrated in FIG. 9, an air layer between the protective film 9 and the platen roller, which is generated by the steps of the electrodes 8, can be eliminated, to thereby improve the printing efficiency.

Further, in the thermal head 1 according to this embodiment, the inclined surfaces 8C of the pair of electrodes 8 are formed at an angle ranging from 15° to 60° with respect to the support substrate 3. In this manner, in the burying step S3, the region between the pair of electrodes 8 can be suitably buried, to thereby improve the flatness of this region. Therefore, in the protective film forming step S4, the protective film 9 can be uniformly formed.

Hereinabove, the embodiment of the present invention has been described in detail with reference to the accompanying drawings. However, specific structures of the present invention are not limited to the embodiment, and include design modifications and the like without departing from the gist of the present invention.

What is claimed is:

1. A method of manufacturing a thermal head, comprising:
forming a heating resistor on a substrate;
forming a pair of electrodes on the heating resistor so as to be spaced apart in a direction along a surface of the heating resistor, the pair of electrodes respectively having inclined surfaces which are spaced apart from each other as a distance from the substrate increases;
burying a region between the pair of electrodes; and
forming a protective film on the buried region and on the pair of electrodes.

2. A method of manufacturing a thermal head according to claim 1, wherein the forming a pair of electrodes comprises:
forming an electrode layer on the substrate;
forming a first mask on the electrode layer on both sides of the heating resistor with a space therebetween;
removing a region of the electrode layer, which is not covered with the first mask, by etching processing with use of solvent having permeability; and
removing the first mask.

3. A method of manufacturing a thermal head according to claim 1, wherein the burying comprises:
forming a second mask on the pair of electrodes;
forming a burying film between the pair of electrodes and on the second mask; and
removing the second mask.

4. A method of manufacturing a thermal head according to claim 2, wherein the burying comprises:
forming a second mask on the pair of electrodes;
forming a burying film between the pair of electrodes and on the second mask; and
removing the second mask.

5. A method of manufacturing a thermal head according to claim 1, wherein the inclined surfaces are each formed at an angle ranging from 15° to 60° with respect to the substrate.

6. A method of manufacturing a thermal head according to claim 2, wherein the inclined surfaces are each formed at an angle ranging from 15° to 60° with respect to the substrate.

7. A method of manufacturing a thermal head according to claim 3, wherein the inclined surfaces are each formed at an angle ranging from 15° to 60° with respect to the substrate.

8. A method of manufacturing a thermal head according to claim 4, wherein the inclined surfaces are each formed at an angle ranging from 15° to 60° with respect to the substrate.

9. A thermal head, comprising:
a heating resistor provided on a substrate;
a pair of electrodes provided on the heating resistor so as to be spaced apart in a direction along a surface of the heating resistor, the pair of electrodes respectively having inclined surfaces which are spaced apart from each other as a distance from the substrate increases;
a burying film for burying a region between the pair of electrodes; and
a protective film formed on the region buried by the burying film and on the pair of electrodes.

10. A thermal head according to claim 9, wherein the inclined surfaces are each formed at an angle ranging from 15° to 60° with respect to the substrate.
